(19) United States
(12) Patent Application Publication
(10) Pub. No.: US 2016/0119705 A1
(43) Pub. Date: Apr. 28, 2016

(54) UNIVERSAL SMART MOBILE ELECTRONIC GEAR HUB AND SPECIALTY EARPHONE CASE

(71) Applicant: John Ramirez, San Diego, CA (US)

(72) Inventor: John Ramirez, San Diego, CA (US)

(21) Appl. No.: 14/817,128

(22) Filed: Aug. 3, 2015

Related U.S. Application Data
(60) Provisional application No. 61/999,602, filed on Aug. 1, 2014.

(51) Int. Cl. H04R 1/10

(52) U.S. Cl. CPC H04R 1/1033; H04R 1/1041; H04R 2420/09

(57) ABSTRACT

A universal smart mobile electronic gear hub and specialty earphone case device for providing a user with functional tools, sensors, input/output interfaces, and electronic features in an easy to use, handheld, 360 degree form factor. The universality of the present invention in a novel form factor facilitates a new level of user interface, connectivity, monitoring, and systems for a plurality of technology devices. The smart mobile electronic gear hub and specialty earphone case provides a profound technological advancement and is the next logical progression to the smartphone.

### CROSS-REFERENCE TO RELATED APPLICATION

The present application claims priority to U.S. Provisional Patent Application No. 61/999,602, filed on Aug. 1, 2014, entitled “Multi-Functional Earphone and or Efficiency Case Computer, Controller, and Method Thereof Incorporating Electronic Display, Lighting, Memory Battery Back Up, Plug in Ports, Mp3 Player, Speaker, Wind, Solar Power Generator, Wireless Info Power Transfer in Hard Protective Case Housing for the Like,” the entire disclosure of which is incorporated by reference herein.

### BACKGROUND OF THE INVENTION

1. Field of Invention

This invention relates generally to electronic devices and, more specifically, to a novel universal smart mobile electronic gear hub and specialty earphone case configured to provide connectivity with another electronic device and to provide a plurality of functional and all purpose electronic tools, sensors, input/output interfaces, and features.

2. Description of Related Art

Technologically savvy individuals utilize portable electronic devices, such as smart phones, tablets, and laptop computers, for a variety of purposes. Often, the tech-savvy individuals utilize multiple peripheral devices, such as digital cameras and video cameras, microphones, speakers, fitness trackers, security sensors, smart watches, etc., to expand the functionality of their portable electronic device. One individual might utilize many peripheral devices at once, for example, a Samsung smart watch, FitBit®, wireless speakers, and a GoPro® video camera. Many peripheral devices, however, require proprietary cables, charging stations, and/or mobile device apps for connectivity, communication, and power. For the tech-savvy enthusiast, the use of peripheral devices in conjunction with their portable electronic device is therefore cumbersome and inhibiting. Because of the increasing portability of today's electronic devices and included features, versatile, tech-savvy users are seeking to combine as much functionality into one device as possible. Multipurpose tools are designed to permit the user to carry a number of tools within a common frame. Typically, the multipurpose tool is designed for a specific application wherein the common frame houses a number of tools relevant for that application. The Swiss Army Knife is a well known example of a general use multipurpose tool designed typically for outdoor activities such as camping, hiking, fishing, etc. No such device, however, exists in the computer world. A need therefore exists for a universal electronic device having a common housing enabling a plurality of electronic components and features, multiple types of connectivity for communications, as well as ancillary electronic tools geared to the tech-savvy enthusiast.

### SUMMARY OF THE INVENTION

The present invention overcomes these and other deficiencies of the prior art by providing a universal smart mobile electronic gear hub and specialty earphone case housing that enables a plurality of electronic components and features, multiple types of connectivity for communications, as well as numerous ancillary electronic tools geared to the tech-savvy enthusiast. The present invention provides numerous electronic capabilities in a unique hand held device that is shock resistant and water proof. The device serves as a hub for bringing personal electronic communications gear into a single form factor. The device serves as an interface to a smartphone, tablet, or any electronic device. The smart mobile electronic gear hub and specialty earphone case provides a profound technological advancement and is the next logical progression to the smartphone.

In an embodiment of the invention, the present invention provides a universal multifunctional electronic case for housing mobile electronic interface systems and provides a method for improved use of earphones, speakers, music players, camera/video cameras, microphones, and other electronic sensors/tools/components. The smart mobile electronic gear hub and specialty earphone case as disclosed herein enhances personal communications as a smartphone accessory.

The present invention overcomes the deficiencies of the prior art by providing a universal electronic device comprising a housing having a cylindrical sidewall and an upper surface forming a generally hollow interior space. The housing is movable relative to a base portion. A central portion having a smaller concentric continuous sidewall than the housing cylindrical sidewall is configured to be housed within the hollow interior space of the housing and configured to receive a plurality of technology devices as described herein. The central portion defines a cavity configured to receive a hardware central processing unit (CPU). A software module enabling communications and data transfer between the universal electronic device and a technology device provides the executable instructions to the CPU.

The present invention provides a method of retrieval and storage of earphones, earphone cables, and earphone jacks from a universal electronic device. The method includes the step of accessing a central portion of the universal electronic device. The user is then able to adjust the central portion to the size, dimension, and length of an earphone, earphone cable, and earphone jack. The user may locate identifying elements of the central portion through touch and feel and store and/or retrieve the earphone, earphone cable, and earphone jack in low-light and/or no-light conditions.

The present invention is advantageous in that it provides a platform that can be used as a controller, computer, monitoring sensor to facilitate a new and improved level of mobile palm pocket gear capability, thereby completing multifunctional 360 degree spectrum of electronic capabilities.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exploded view of the universal smart mobile electronic gear hub and specialty earphone case device according to one embodiment of the present invention;

FIG. 2 illustrates the universal device of FIG. 1 from a top perspective view;

FIG. 3 illustrates the universal device of FIG. 1 in a closed configuration from a side perspective view;

FIG. 4 illustrates the universal device of FIG. 1 in an open configuration;

FIG. 5 illustrates an exploded view of the central portion of the universal device of FIG. 1;

FIG. 6 illustrates the base portion of the universal device of FIG. 1 with a cutout of the spring activated push-button locking mechanism;

FIG. 7 illustrates a blow up of the push-button locking mechanism cutout of FIG. 6;

FIG. 8 illustrates the housing of the universal device of FIG. 1 with a cutout of the sliding rail system;

FIG. 9 illustrates a blow up of the cutout of FIG. 8; and

FIG. 10 illustrates another view of the housing and central portion of the universal device of FIG. 1 including details of the sliding rail system.

### DETAILED DESCRIPTION OF PREFERRED EMBODIMENTS

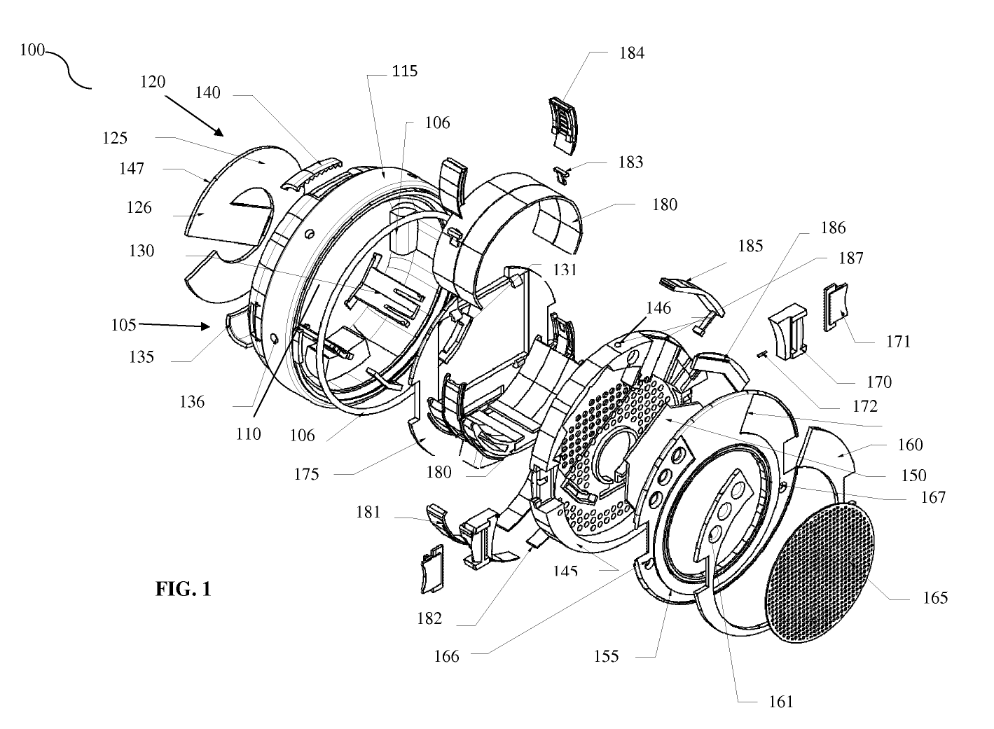

Preferred embodiments of the present invention and their advantages may be understood by referring to FIGS. 1-10, wherein like reference numerals refer to like elements. Although the present invention is described and illustrated in the context of an electronic housing having a hockey puck like form factor, the present invention can be utilized in any type of form factor.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

It is to be understood that throughout the description of the invention herein the terms “universal device,” “multifunctional device,” and “device” have the same meaning and will be used interchangeably to describe a universal smart mobile electronic gear hub and specialty earphone case device equipped with a plurality of electronic capabilities.

Likewise, it is to be understood that many of the components and embodiments described herein may include proprietary or non-proprietary hardware, firmware, software, and/or any combination thereof. It will be recognized by those skilled in the art, when implemented in the universal device as described herein, the hardware, firmware, software, and/or any combination thereof may be customizable to facilitate incorporation into and proper functioning within the form factor illustrated in the figures.

The form factor of the present invention provides the user with an ergonomic, simple to use, handheld universal device capable of connectivity to a plurality of technology devices. Because there are no stress points, i.e. corners, the form factor of the present invention disperses any impact from dropping, etc., thereby making the present invention ideal for any number of activities. The shock resistance capabilities of the present invention may be attributed to the form factor itself, the material used to construct the device, such as rubber or the like, or through the use of gimbal technology, bushings, or the like.

The universal device described herein is characterized by the inclusion of a specialty earphone case. The specialty earphone case includes a system and method of retrieval and storage. The universality of the device facilitates the inclusion in the specialty earphone case of any earphone, earphone cable, and earphone jack of various sizes, dimensions, and lengths. The unique architecture and adjustability of the universal device creates a system and method of earphone retrieval and storage that may be implemented by the user in low-light and/or no-light conditions as well as by the seeing impaired.

The universal device described herein is characterized by the ability to facilitate inclusion and/or connectivity with a plurality of technology devices and features. The technology devices may be included within the universal device or may be connected to and in communication with the universal device via a wired connection or wireless connection. A networked computing device is coupled to the universal device via a communications protocol, the identification and implementation of which is apparent to one of ordinary skill in the art. It is to be understood that the networked computer device may be any electronic device such as, but not limited to, a smartphone, tablet, laptop, game console, or personal computer. The technology device may be any electronic device such as, but not limited to an accelerometer, a compass, a global positioning unit, a display, a camera, a video streamer, a video camera, a microphone, a speaker, a health monitoring device, a clock, a music player, a breathalyzer, a photometer, an alarm or security system, a medical device, a proximity sensor, a chemical sensor, a water quality sensor, an air quality sensor, a smoke or fire alarm, stylus, USB dongle, LED light strip, smart watch, garage door controller, television remote controller, a mouse, treadmill, bicycle computer, thermometer, altimeter, eWriter, sports equipment, video gaming accessory, remote power supply, drone, lamp, tire pressure sensor, lock, laser measure, posture sensor, hearing aid or hearing assistance device, vibration device that may include positioning capabilities, and the like.

The universal device described herein is characterized by scalability. In various embodiments, the universal device described herein has a wide range of suitable scales and sizes. Those of ordinary skill in the art will recognize that the most suitable scale for a particular application varies with, for example, the need for portability, tolerance of expense, environmental exposure, the number and type of features desired, and the like.

In some embodiments, the universal device is linked to a networked device that is a digital processing device such as, but not limited to, a smartphone, tablet, laptop, game console, access point, and/or personal computer, and includes one or more hardware CPUs that carry out the device's functions. In further embodiments, the networked device and/or universal device includes an operating system configured to perform executable instructions. The operating system is, for example, software, including programs and data, which manages the device's hardware and provides services for execution of applications such as, by way of non-limiting examples, Apple® Mac OS X Server®, Windows Server®, and the like. Those of skill in the art will recognize that suitable personal computer operating systems include, by way of non-limiting examples, Microsoft® Windows®, Apple® Mac OS X®, and the like. In some embodiments, the operating system is provided by cloud computing. Those of skill in the art will also recognize that suitable mobile smart phone operating systems include, by way of non-limiting examples, Apple® iOS®, Google® Android®, Microsoft® Windows Phone® OS, and the like.

In some embodiments, the universal device comprises volatile memory and requires power to maintain stored information. In some embodiments, the device comprises non-volatile memory and retains stored information when the universal device is not powered. In further embodiments, the non-volatile memory comprises flash memory. In some embodiments, the volatile memory comprises dynamic random-access memory (DRAM). In further embodiments, the storage and/or memory capabilities are a combination of devices such as those disclosed herein.

In some embodiments, the universal device includes a microphone and/or speaker to capture or send voice or other sound input or output. In other embodiments, the device includes one or more video cameras to capture motion or visual input. In still further embodiments, the device includes a high resolution video camera capable of capturing spherical motion or visual input in 360 degrees. In still further embodiments, the device includes an infrared camera and/or night vision camera. In yet a further embodiment, the device includes motion sensing capabilities, which may be a camera and/or a video camera with 360 degree or infrared capabilities, configured to trigger an audible alarm or activation of the video camera and microphone to capture motion, audio, and visual input. In still further embodiments, all operations of the device can be controlled via computer logic voice activated commands to keep the user hands free and connected at the same time.

In some embodiments, the universal device includes a visual component (e.g., LCD display) to provide a user interface that may be in color and/or possess high resolution capabilities. In still further embodiments, the device includes as a component of the user interface touch screen capabilities and/or physical inputs such as buttons. In still further embodiments, the device includes electronic authorization capabilities via the user interface to allow or deny access to the device. In other embodiments, the device comprises a biometric capture device such as, but not limited to a fingerprint scanner to permit biometric authentication and/or identification. Alternatively, a microphone or camera can be used to acquire biometric data input.

In some embodiments, the universal device includes an accelerometer. The accelerometer may be a single-axis or multi-axis accelerometer. In addition, the universal device may include an electronic compass. The accelerometer and electronic compass of the present invention can be any accelerometer and electronic compass known to those of ordinary skill in the art and may be used to measure motion. In still further embodiments, the universal device includes sensors capable of capturing temperature, heart rate, steps taken, calories burned, and distance traveled.

In some embodiments, the universal device communicates with a networked device such as, but not limited to a smartphone, tablet, laptop, and/or personal computer, via one or more wireless protocols including, by way of non-limiting examples, infrared, Bluetooth, ZigBee, IEEE 802(x) (“Wi-Fi”), cellular 3G/4G wireless protocols, radio frequency identification (RFID) and/or near-field communication (NFC) protocols, the implementation of which are apparent to one of ordinary skill in the art. NFC protocols may be used alone or in combination with other wireless protocols to remove the need for performing scans to identify the networked device, entering passcodes, and removing the risk of establishing a connection with the wrong networked device. In still further embodiments, the device communicates via satellite capabilities. Those of skill in the art will recognize the most appropriate components necessary to facilitate communication between the universal device and the networked device. In still further embodiments, the universal device may be a social communications hub. The wireless capabilities of the universal device permit the user and/or multiple users to communicate via social networks, social media, and the like.

In accordance with the description herein, suitable networked devices include (or are based on), by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, television or satellite cable boxes, cellphones, video game consoles, and other universal devices according to the present invention. In some embodiments, the device acts as a hub facilitating communication between any number of technology devices as described herein. Those of skill in the art will recognize that many smartphones are suitable for use with the universal device described herein. Those of skill in the art will also recognize that select televisions and select digital music players with computer network connectivity are suitable for use with the universal device described herein. The networked device may also be an Internet access point.

In some embodiments, the universal device includes an interface for wired connection, communication, and power supply with another technology device such as, but not limited to a smartphone, tablet, laptop, and/or personal computer. For example, the interface can be a universal serial bus (USB) port.

In some embodiments, power is supplied to the universal device via a USB interface with the networked device. In other embodiments, power is supplied to the universal device directly from a wall socket or the like. In still further embodiments, the universal device comprises and is powered by a rechargeable lithium ion battery, alkaline battery, or the like. In still further embodiments the universal device is powered by one or more photovoltaic cells included with the device. In some embodiments, the device is powered through wireless charging technologies, such as inductive charging or any non-contact charging technology known to one or ordinary skill in the art. The wireless charging capabilities may be housed within the universal device or be a separate peripheral option.

In some embodiments, the device itself is a portable charging station for power hungry electronic devices and includes a rechargeable battery pack. Those of ordinary skill in the art will understand the requisite milliampere hours necessary to facilitate the charging capabilities of the present invention depending upon the end use and particular embodiment.

In some embodiments, the universal device disclosed herein includes one or more non-transitory computer readable media encoded with a program including instructions executable by the operating system of the universal device or an optionally networked digital processing device. In some cases, the program and instructions are permanently, substantially permanently, semi-permanently, or non-transitorily encoded on the media.

In some embodiments, the universal device disclosed herein includes at least one computer program. A computer program includes a sequence of instructions, executable in the universal device's CPU, written to perform a specified task. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In another embodiment, the device comprises water testing equipment such as, but not limited to a photometer to detect dangerous amounts of contaminants. In another embodiment, the device comprises a breath analyzer to measure alcohol level.

The following provides an exemplary housing structure for the above-noted components. In this exemplary embodiment, the form factor of the housing is shaped similarly to a hockey puck. The form factor of the housing provides shock resistance and ease of use and transport.

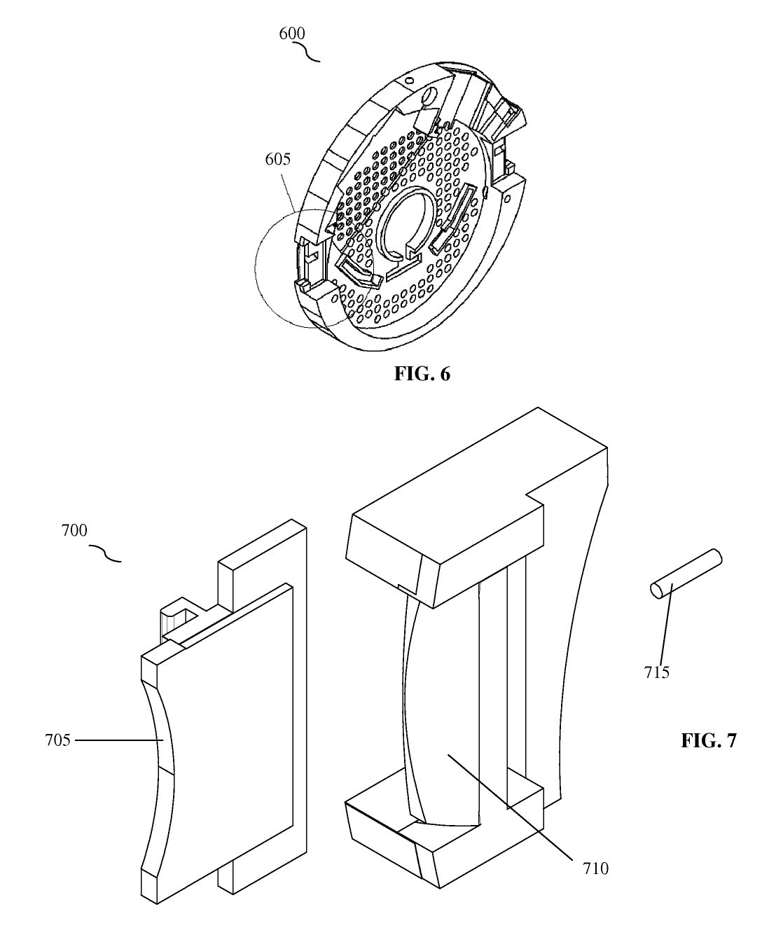

Referring to FIG. 1 is an exploded view of the universal device 100 according to one embodiment of the present invention. A housing 105 provides protection for the components of the present invention. The housing 105 may be made of any suitable material and may be translucent or opaque. The housing 105 may be made of a material suitable to provide shock resistance. Moreover, the housing 105 when in the locked position, as described herein, provides a water tight seal. A gasket 106 creates a water tight seal between the housing and base portion 145. The housing 105 is configured to define a cavity 110 wherein the cavity 110 is surrounded by a continuous side wall 115 and an upper surface 120. The upper surface 120 may include an inlaid portion (not shown) to accommodate a logo 125, design, or the like. Hidden push control buttons 126 may be included in the inlaid portion (not shown) and covered by the logo 125 or the like. The continuous side wall 115 is configured to include a locking mechanism 130. In a preferred embodiment, as shown in FIG. 1, the locking mechanism 130 is a sliding rail system wherein the sliding rail system includes a plurality of male and female portions such that the housing 105 is movable upward or downward with respect to the base portion 145. The sliding rail system locks into the base portion 145 by a tapered cantilever groove and tab locking mechanism 131 (described in further detail in FIGS. 6-9 below). In further embodiments, the locking mechanism 130, may be any locking mechanism, such as latches, fasteners, magnets, and the like., known to those of ordinary skill in the art and appropriate for the specific embodiment of the invention described herein.

The continuous side wall 115 includes at least one light 135 and may include at least one contrasting color light 140. Those of ordinary skill in the art will appreciate that the lights of the present invention can be any light source such as LED or the like. According to some embodiments of the present invention, the light lens of the at least one light 135 and 140 may be any color and/or the light source itself may be of a type that emits a particular color depending on the programming from the devices CPU. In some embodiments of the present invention, the light source may be voice activated through the microphone of the device or simply through push-button or touchscreen control via the user interface. In further embodiments, the light source may be controlled via a wireless connection such as Bluetooth or the like. The light source of the present invention may be used as a signaling system to indicate direction, location, etc.

The housing 105 may be configured to include at least one camera and/or video camera sensor 136 capable of capturing spherical motion or visual input in 360 degrees. A base portion 145 of the present invention is configured to house a speaker assembly. The speaker assembly includes a speaker (not shown), substantially the same dimensions as the base portion 145, a front wall 155, a protective inlay 160, and a speaker grill 165. The base portion 145 may be configured to include a microphone (not shown). The speaker assembly of the present invention includes enhanced acoustic properties due to the hollow interior space created by housing 105 and a central portion 180 (described in more detail below) and whether in an open or closed configuration. The protective inlay 160 may be made of any suitable material known to those of ordinary skill in the art, such as rubber, silicone, plastic, wood, and composites thereof. The protective inlay 160, is configured to include input control buttons 161 to provide the user the ability to control speaker features. In alternative embodiments, the speaker assembly may be absent or of smaller dimensions to accommodate alternative components as described herein. Mounting holes 166 and 167 allow the speaker assembly to be mounted as a single unit to base portion 145.

Base portion 145 is configured to receive a circuit board 150. The circuit board 150 may be a printed circuit board (PCB) and is configured to interface with and interconnect all the components necessary for the functioning of the universal device as described herein. In some embodiments, base portion 145 houses the electronics necessary for the proper functioning of the universal device described herein and may or may not include a circuit board.

The base portion 145 is configured to include a locking tab 170 to reversibly attach the housing 105 via the locking mechanism 130. The locking tab 170 may be any locking-like tab required to facilitate the locking mechanism 130, e.g., push-button, latches, fasteners, magnets, and the like. The embodiment of FIG. 1, shows a spring activated push- button locking mechanism including a locking tab 170 to engage the locking mechanism 130 of the housing 105, push-button 171 to release locking tab 170, and spring actuator 172 to engage and disengage push-button 171. In still further embodiments, the housing 105 may be hingedly attached to the base portion 145 and include a locking mechanism opposite the hinge. In still further embodiments, the housing and the base portion are configured to transition between an open configuration and a closed configuration. In a preferred embodiment, in the open configuration, the housing 105 remains in contact with the base portion 145. The housing may remain in contact with the base portion by any method known to one of ordinary skill in the art such as a tether or a rail system configured with a stop such that the housing moves upward relative to the base portion until contact is made with the stop. In this embodiment, the open configuration allows the housing to remain in contact with the base portion but permits access to the interior central portion 180 (described below).

According to one embodiment of the present inventions, housed within the cavity 110, is a battery wall 175 configured to accommodate a battery as described herein or other power components, such as photovoltaic cells. In some embodiments, the battery wall 175 is configured as a universal utility wall to interface and connect with the various technology devices and components described herein. The various embodiments of the present invention, including the embodiment of FIG. 1, include a Braille system to assist those that require assistance due to blindness or impaired eyesight. The Braille system may be located anywhere on the device where access and control of the device may be required such as at 146 for accessing the earphones (not shown) and 147 for accessing the control buttons. The embodiment of FIG. 1 may also include identifying elements, such as in a Braille system, that may be raised elements relative to the surface of the device or may be the unique configuration of the particular component of the device, such as the earphone or the earphone jack location within the device. These identifying elements assist the user operating the universal device in low-light or no-light conditions.

The central portion 180 is a continuous wall of smaller circumference than the continuous side wall 115. A cavity is defined by the central portion 180 and is configurable to accommodate the various embodiments of components as described herein, i.e., computer hardware, electronic components, etc. Cover 185 provides protection of the various ports of the device including USB, MP3, earphone, and the like located at 187. The cover 185 may be of a sliding type that slides around a preset distance along the circumference of the central portion 180. In some embodiments, the cover 185 may be a plug form cover where the plug is molded to the dimensions of the various ports included in the device. A sliding lock mechanism 186 provides the locking mechanism of the port cover 185. The central portion 180 is likewise configured to accept earphones, earphone cables, and earphone jacks (not shown). The adjustable track system 181 and 182 is configured to include locking tongue 183 and groove tracks 184. The adjustable track system 181 and 182 is adjustable inwardly or outwardly with respect to the center point of the universal device 100. The several embodiments of the present invention will accommodate earphones of various shapes and configurations. The earphones may be hardwired or wireless. If hardwired, then this embodiment of the present invention may be configured to include a retractable spring-loaded coiling mechanism (not shown) to retract the earphone cable when not in use. In an alternative embodiment, the hardwired earphone may simply be manually wound around the central portion 180 for storage when not in use.

FIG. 2 illustrates a top perspective view of the universal device 200. The upper surface 220 of the universal device 200 includes an inlaid portion to receive a logo 225. The logo 225 may provide concealment of control buttons (not shown) located, for example, at 230. The control buttons located, for example, at 230 may be push-button control buttons accessible by pushing through the logo 225, which may be of any suitable material to facilitate this access such as rubber, silicone, or the like. In an alternative embodiment the push-button controls may be accessible directly without the need to push through a logo, design, or the like. Lights 235 and 240 are housed in the upper surface 220. The upper surface 220 is configured to receive a plurality of male and female portions, 245, 250, and 255, of the sliding rail system as described with respect to the locking mechanism 130 of FIGS. 1 and 6-9 below.

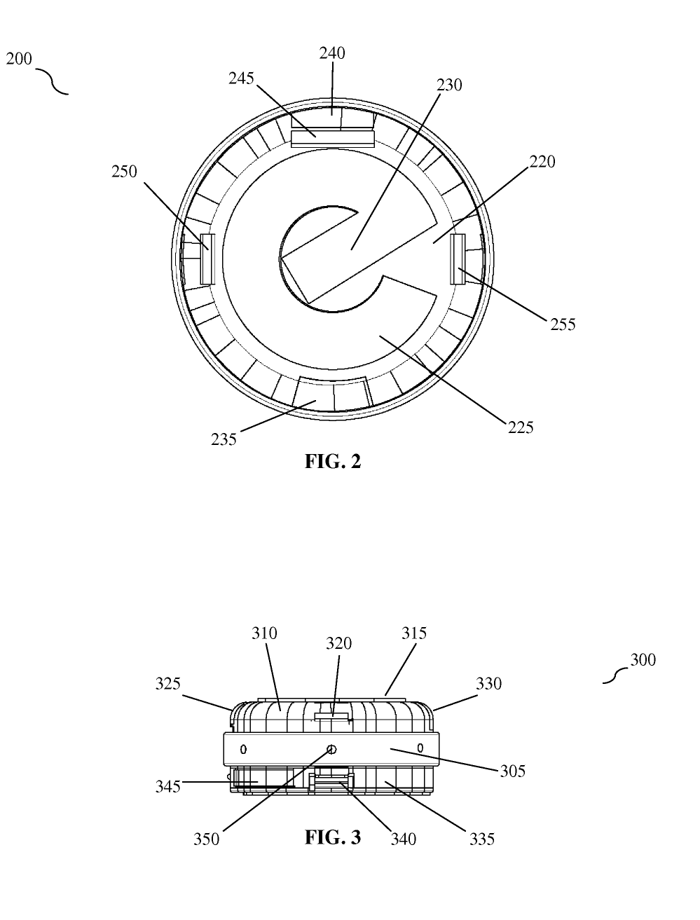

FIG. 3 illustrates a closed configuration from a side perspective view of the universal device 300. The universal device 300 includes an overlay 305 which may be made of any suitable material, such as rubber, silicone, or the like, to act as a protectant and provide additional shock resistance. Upper portion 310 includes an inlaid logo 315, a plurality of male and female portions 320 of the sliding rail system as described with respect to the locking mechanism 130 of FIGS. 1 and 6-9 below, and a plurality of lights 325 and 330. Base portion 335 includes a spring activate push-button locking mechanism 340 and a port cover 345. The overlay 305 is configured to receive at least one camera and/or video camera 350 capable of capturing spherical motion or visual input in 360 degrees. The at least one camera and/or video camera 350 configuration is known to one of ordinary skill in the art but may be, as a non-limiting example, a camera sensor such as OmniVision Technologies, Inc. Sensor Camera CMOS 20CameraCube OVM7690-R20A.

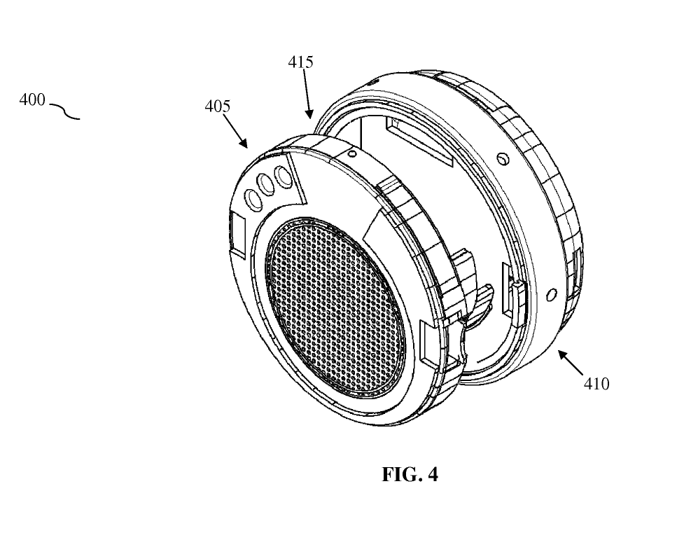

FIG. 4 illustrates the universal device 400 in an open configuration. Viewed from the base portion 405, illustrated is the open configuration of the universal device 400 with the housing 410 upwardly movable with respect to base portion 405. In the open configuration of the universal device 400, a cavity 415 is created between the housing 410 and the base portion 405. The defined cavity 415 houses the central portion (not shown) as illustrated and described in FIG. 1 as reference numeral 180. In an open configuration, the universal device inherently has enhanced acoustic properties for the speaker assembly described herein.

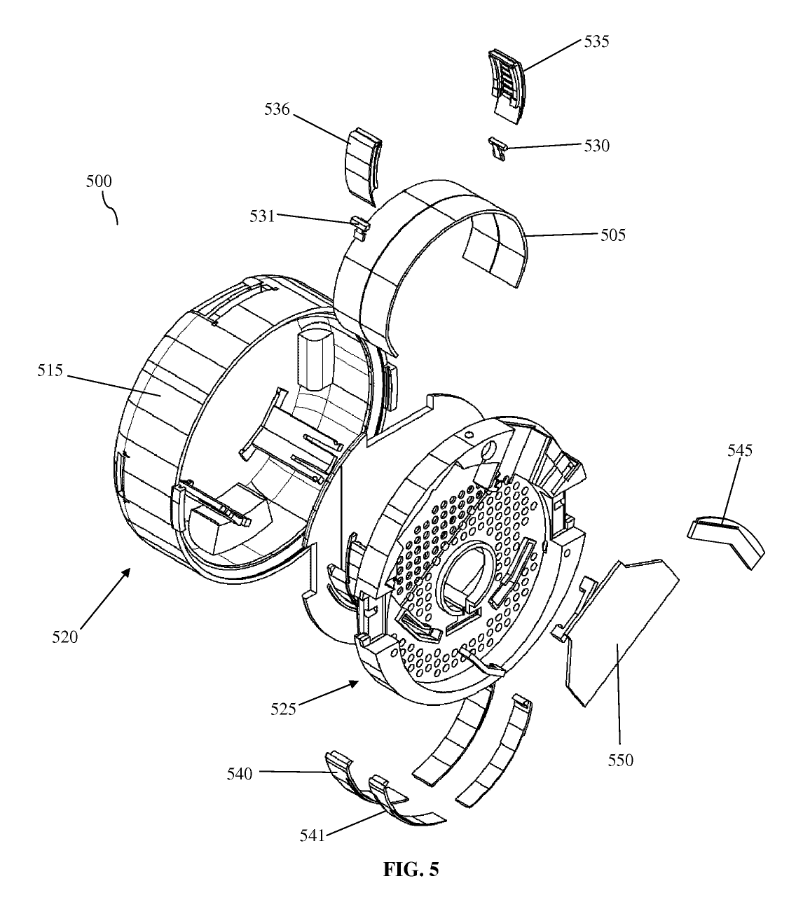

FIG. 5 illustrates an exploded view of the central portion of the universal device 500 relative to the housing 520 and base portion 525. The central portion 505 is a continuous wall of smaller circumference than the continuous side wall 515 of the housing 520. In an alternate embodiment, the wall of smaller circumference than the continuous side wall 515 includes a plurality of sections. The sections may be interlocking and coupled to one another as described herein with respect to the adjustable track system. The adjustability of this central portion is key to the specialty earphone case embodiment of the present invention. The circumference of the central portion 505 is configured to include an adjustable track system 540 and 541. The adjustable track system 540 and 541 is configured to include locking tongue 530 and 531 and groove tracks 535 and 536. Those of ordinary skill in the art will appreciate that any adjustable locking configuration appropriate for the adjustability of the central portion may be used. The adjustable track system 540 and 541 is adjustable inwardly or outwardly with respect to the center point of the universal device 500. The adjustable track system 540 includes at least one track. In an embodiment including multiple tracks as shown in FIG. 5, the individual tracks of the adjustable track system 540 may adjust independently with respect to each other. The inward and outward adjustment allows the specialty earphone case embodiment of the universal smart mobile electronic gear hub and specialty earphone case to receive earphones, earphone cables, and earphone jacks of various sizes, dimensions, and lengths. A sliding lock mechanism is illustrated at 545 and provides the locking mechanism of the port cover (not shown) described with respect to reference numeral 185 of FIG. 1. Base portion 525 is configured to receive a circuit board 550. The circuit board 550 may be a printed circuit board (PCB) and is configured to interface with and interconnect all the components necessary for the functioning of the universal device as described herein.

FIG. 6 illustrates another view of the base portion 600 with a cutout at 605 illustrating more details of the spring activated push-button locking mechanism blown up in

FIG. 7. Referring to FIG. 7 is a blow up of the spring activated push-button locking mechanism 700 as included in the base portion (not shown) of the universal device. The push- button 705 is movable with respect to the housing portion 710 of the spring activated push-button locking mechanism 700 and engages the sliding rail system (not shown) of the universal device. Spring 715 is housed in the housing portion 710 of the spring activated push-button locking mechanism 700 opposite the push-button 705. Spring 715 returns the push-button 705 to its original position and allows the disengagement of the sliding rail system (not shown) to unlock the housing (not shown) from the base portion (not shown) of the universal device.

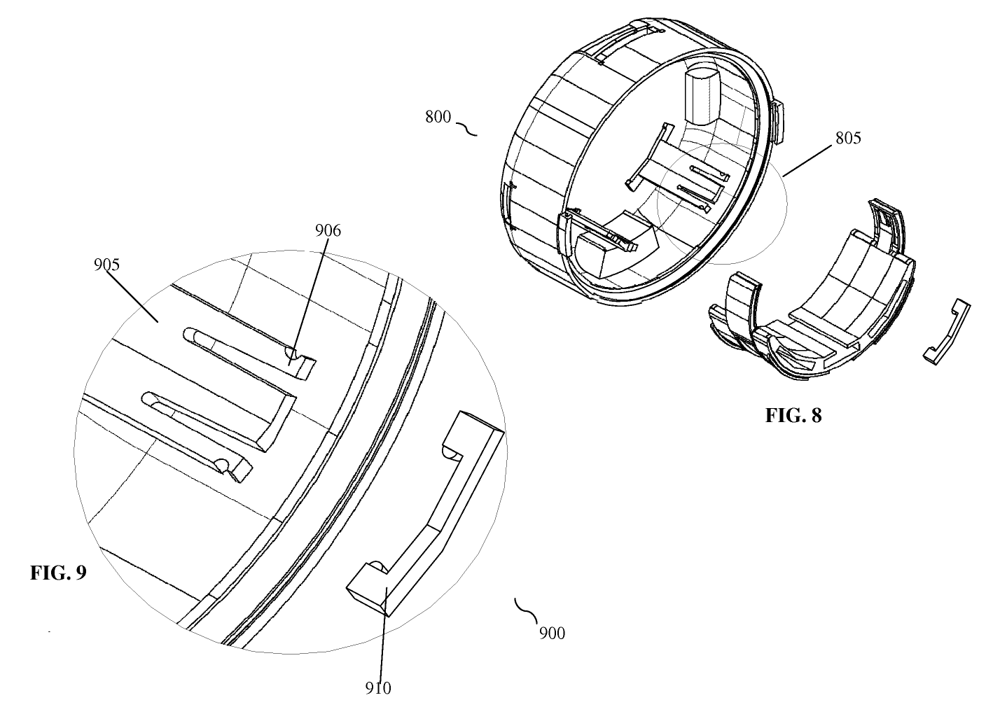

FIG. 8 illustrates another view of the housing 800 with a cutout at 805 illustrating more details of the sliding rail system as blown up in FIG. 9. Referring to FIG. 9 is a blow up of the sliding rail system 900. The sliding rail system 900 is configured to allow the housing to move with respect to the base portion of the universal device. In the embodiment of FIG. 9, the sliding rail system 900 includes a male rail portion 905 including a cantilever tab portion at 906 configured to engage the locking tab 910 of the base portion (not shown) as described above in the description of FIG. 1. Although the description herein of FIG. 9 is limited to one sliding rail system, it is to be understood that the universal device of the present invention includes at least one sliding rail system.

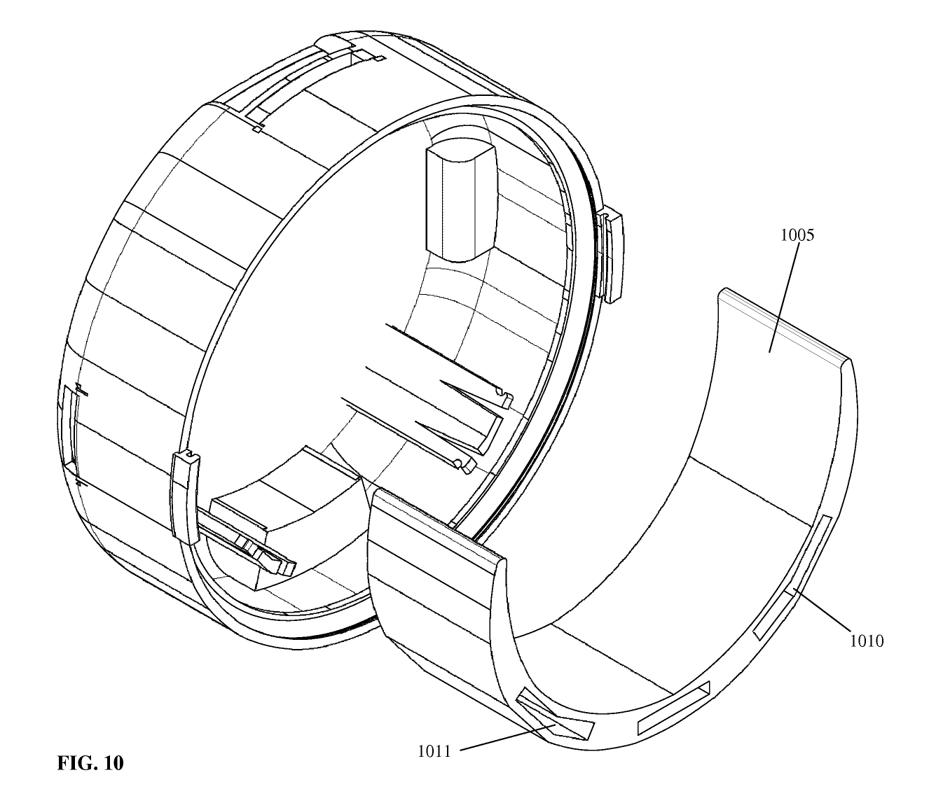

FIG. 10 illustrates another view of the central portion 1005 with detail illustrating the female guides 1010 and 1011 of the sliding rail system as described with respect to FIGS. 1 and 6-9. Central portion 1005 illustrates an alternate embodiment of the present invention wherein the central portion 1005 includes a plurality of interlocking sections as described with respect to FIG. 5 herein.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A universal electronic device comprising:
a housing having a cylindrical sidewall and an upper surface forming a generally hollow interior space;
a base portion, wherein the base portion is movable relative to the housing;
a central portion having a smaller concentric continuous sidewall than the housing cylindrical sidewall, the central portion being configured to be housed within the hollow interior space of the housing and configured to receive a plurality of technology devices, wherein the central portion defines a cavity configured to receive a hardware central processing unit;
a software module enabling communications and data transfer between the universal electronic device and a technology device.

2. The device of claim 1, wherein the base portion includes a universal serial bus port.

3. The device of claim 1, wherein the technology device is a networked device selected from the group consisting of: a cellular telephone, smartphone, tablet, laptop, and computer.

4. The device of claim 1, wherein communication and data transfer with the networked device is facilitated by a communications protocol selected from the group consisting of:
audio port, microphone jack, USB mini/micro-connector, USB Type A or Type B connector, infrared, satellite, Bluetooth, ZigBee, Wi-Fi, 3G/4G wireless protocols, RFID, and NFC protocols.

5. The device of claim 1, wherein the housing and the base portion comprise a locking mechanism.

6. The device of claim 5, wherein the housing and the base portion in a locked position create a watertight seal.

7. The device of claim 1, wherein the device is shock resistant.

8. The device of claim 1, wherein the housing and the base portion are configured to transition between an open configuration and a closed configuration.

9. The device of claim 8, the device being in an open configuration, wherein the housing is in contact with the base portion.

10. The device of claim 1, wherein the base portion further comprises a speaker.

11. The device of claim 1, wherein the housing includes at least one light source.

12. The device of claim 1, wherein the central portion is configured to receive an earphone, an earphone cable, and an earphone jack.

13. The device of claim 12, wherein the central portion includes an adjustable track system to receive earphones, earphone cables, and earphone jacks of various sizes, dimensions, and lengths.

14. The device of claim 13, wherein the central portion further includes identifying elements for the storage and retrieval of the earphones, earphone cables, and earphone jacks of various sizes, dimensions, and lengths in low-light and/or no-light conditions and can be accomplished by the seeing impaired.

15. The device of claim 1, wherein the device further comprises a power source selected from the group consisting of: rechargeable lithium ion battery, alkaline battery, alternating current, direct current, universal serial bus connected to a technology device, wind electrical generator, and photovoltaic cell.

16. The device of claim 1, further comprising a battery pack capable of providing a charge to a technology device.

17. The device of claim 1, further comprising a camera and/or video camera.

18. The device of claim 17, wherein the camera and/or the video camera is configured to capture spherical content in 360 degrees.

19. The device of claim 1, further comprising a display.

20. The device of claim 1, further comprising a biometric scanner.

21. The device of claim 1, further comprising an accelerometer.

22. The device of claim 1, further comprising a compass.

23. The device of claim 1, further comprising , volatile and non-volatile memory.

24. A method of retrieval and storage of earphones, earphone cables, and earphone jacks from a universal electronic device including the steps of:
accessing a central portion of the universal electronic device;
adjusting the central portion to the size, dimension, and length of an earphone, earphone cable, and earphone jack;
locating identifying elements of the central portion through touch and feel; and
storing and/or retrieving the earphone, earphone cable, and earphone jack in low-light and/or no-light conditions.

25. The method of claim 24, wherein a seeing impaired user can operate the retrieval and storage of the earphones, earphone cables, and earphone jacks.
